(19) United States
(12) Patent Application Publication
(10) Pub. No.: US 2023/0092007 A1
(43) Pub. Date: Mar. 23, 2023

(54) APPARATUS AND SYSTEM TO ATTRACT FISH WITH AN ACOUSTICAL LURE

(71) Applicant: Brandon Berrang, Port Orange, FL (US)

(72) Inventor: Brandon Berrang, Port Orange, FL (US)

(21) Appl. No.: 17/477,579

(22) Filed: Sep. 17, 2021

(51) Int. Cl. A01K 85/01

(52) U.S. Cl. CPC A01K 85/01

(57) ABSTRACT

An apparatus and system to attract fish with an acoustical lure comprising the following components: a lure, a loudspeaker, a slot, a hook. By emitting a sound through a loudspeaker predator fish are then attracted to the lure. The lure may be textured or colored to further attract predator fish. A user of an apparatus and system to attract fish with an acoustical lure would select the type of lure style for the predator fish desired, select a loudspeaker with a recording of the appropriate bait fish, insert the loudspeaker into the slot in the lure, attach the lure to a fishing rod and line, activate the loudspeaker, cast the line to an appropriate area to fish.

### BACKGROUND

The following discussion is not to be deemed admitted prior art but merely related art to show possible background and information related to fishing lures.

Various bait fish, like Atlantic Croakers, Pigfish or Spots, emit sounds. These sounds attract predator fish.

Currently, there are solutions to use sound(s) to attract fish. Some of these solutions attempt to use metal rattles with a lure to create sound. Still other solutions have mechanical propeller mechanisms to create sound when moving in the water. Still other solutions use wires and loudspeakers to transmit sound. Still other solutions use remote amplifiers. Each of these solutions fail to meet the needed solution because they are difficult to use, unpredictable, and may not accurately attract the desired type of fish.

Therefore, a need exists for a novel device to use as a lure in conjunction with a sound emitting mechanism to acoustically attract fish.

### BRIEF SUMMARY OF THE INVENTION

This invention relates generally to, but is not limited to, attracting fish with a lure and sound imitating a bait fish.

It is desirable to have an apparatus and system to attract fish with an acoustical lure. Furthermore, it is desirable to have an apparatus and system to attract fish with an acoustical lure that acts like regular bait fish. Furthermore, it is desirable that an apparatus and system to attract fish with an acoustical lure does not interfere with regular fishing. Furthermore, it is desirable that an apparatus and system to attract fish with an acoustical lure allow the lure to slide up the fishing line when a fish is hooked. Furthermore, it is desirable that an apparatus and system to attract fish with an acoustical lure allow for different bait fish recordings to attract different fish. Furthermore, it is desirable the components used to make an apparatus and system to attract fish with an acoustical lure resist exposure to both fresh water and salt water. Furthermore, it is desirable the components used to make an apparatus and system to attract fish with an acoustical lure not harm sea life and be environmentally safe.

The disclosed invention advantageously fills these needs and addresses the aforementioned deficiencies by providing an easy to use, sound emitting lure of varying size, that does not interfere with fishing, attracts different fish with a lure, comprises a loudspeaker, a slot to insert a loudspeaker, a weight, an eyelet to provide structure, a hook to hold the fish when caught.

### BRIEF DESCRIPTION OF THE DRAWINGS

An apparatus and system to attract fish with an acoustical lure is illustrated by way of example, and not by way of limitation, in the figures of the accompanying drawings.

While aspects of an apparatus and system to attract fish with an acoustical lure will be described with reference to the details of the embodiments of the invention shown in the drawings (and some embodiments not shown in the drawings), these details are not intended to limit the scope of the invention.

FIG. 1. A side view of an apparatus and system to attract fish with an acoustical lure, assembled.

FIG. 2. A side view of an apparatus and system to attract fish with an acoustical lure, assembled with a hole and peg coupling device.

FIG. 3. A perspective view of an apparatus and system to attract fish with an acoustical lure, of FIG. 1.

FIG. 4. A perspective view of an apparatus and system to attract fish with an acoustical lure, of FIG. 2.

FIG. 5. A side view of an apparatus and system to attract fish with an acoustical lure, assembled, with spars.

FIG. 6. An exploded side view of an apparatus and system to attract fish with an acoustical lure, assembled, with spars.

FIG. 7. A bottom view of an apparatus and system to attract fish with an acoustical lure, assembled.

### LIST OF FIGURE ITEMS

000 The apparatus and system to attract fish with an acoustical lure
001 A molded fishing lure
002 A hook
003 An eyelet
004 A loudspeaker
005 A slot
006 A weight
007 A hook channel
008 A slot cavity
009 A coupling device
010 A spar

### DETAILED DESCRIPTION

The order of the steps of disclosed processes may be altered within the scope of the invention.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The system to attract fish with an acoustical lure may, however, be embodied in many different forms and should not be construed as being limited to the embodiments set forth herein; rather, these embodiments are provided by way of illustration only and so that this disclosure will be thorough, complete and fully convey understanding to those skilled in the art.

For the purposes of promoting an understanding of the principles of an apparatus and system to attract fish with an acoustical lure, reference will now be made to the embodiments illustrated in the drawings and specific language will be used to describe the same, only as examples and not intended to be limiting.

Fishing rods and reels (hereafter referred to as “fishing rods”), as used herein may be, but are not limited to, offshore rods, surf rods, travel and pack rods, ice rods, center-pin and float rods, fly and Spey rods, trolling rods, casting rods, or spinning rods.

Fishing lures (hereafter referred to as a “lure” or “lures”), as used herein may be, but are not limited to, a type of man-made fishing bait designed to attract a fish's attention. Lures may be equipped with one or more hooks, be hard or soft, come in a variety of sizes and colors, and may include scents.

Fishing hooks (hereafter referred to as a “hook” or “hooks”), as used herein may be, but are not limited to, artificial and soft plastic hooks, bait hooks, bait-holder hooks, octopus hooks, J-hooks, circle hooks, Aberdeen hooks, saltwater hooks, and treble hooks.

Disclosed is an apparatus and system to attract fish with an acoustical lure, comprising the following components: (1) a lure 001; (2) a loudspeaker 004; (3) a slot 005; (4) a hook 002; (5) a weight 006.

These components generally speaking, are configured as follows: (1) a lure 001 has a slot 005; (2) a loudspeaker 004 is inserted into the slot 005 in the lure 001; (3) a hook 002 is inserted into the lure 001; (4) a weight 006 in the lure 001.

The apparatus and system to attract fish with an acoustical lure may also have one or more of the following: a weight 006; an eyelet 003 connected to a weight 006 to pass a fishing line through; a hook channel 007; a hard body lure; a soft body lure; a coupling device 009 to close the slot 005, a slot cavity 008; coloring and reflective features on the lure to attract fish, recordings of particular fish to play on the loudspeaker 004.

The disclosed apparatus and system to attract fish with an acoustical lure is unique when compared with other known devices and solutions because it provides: (1) operation without interfering with how the fishing rod and line are used by the operator; (2) is reusable; (3) allows different fish sounds to be played; (4) mimics bait fish; (5) a method for a lure to slide up the fishing line after a fish takes the hook.

The disclosed apparatus and system to attract fish with an acoustical lure is unique in that it is structurally different from other known devices or solutions. More no specifically, the device is unique due to the presence of (1) a self-contained loudspeaker; (2) a lure that can be made of different materials; (3) no external power source requirements; (4) a hook channel; (5) a slot cavity.

Some embodiments of versions of an apparatus and system to attract fish with an acoustical lure comprise a lure 001 with a slot 005 and a loudspeaker 004 inserted into the slot 005; the slot 005 can be sealed with a coupling device 009; a hook 002 inserted into the lure 001 in a hook channel 007; a weight 006 inside the lure 001 positioned to maintain the center of gravity of the lure 001; an eyelet 003 connected to the weight 006 and the eyelet 003 providing structure to the hook channel 007 in the lure 001 to attach to a fishing rod and line.

In some embodiments of versions of an apparatus and system to attract fish with an acoustical lure a lure 001 may be made of materials like, but not limited to, silicon, plastic, cork, rubber, wood, metal.

In some embodiments of versions of an apparatus and system to attract fish with an acoustical lure a lure 001 is of a length, not meant to be limiting, of 2 inches to 20 inches; a height not meant to be limiting, of 2 inches to 8 inches; a thickness, not meant to be limiting, of ½ inch to 6 inches.

In some embodiments of versions of an apparatus and system to attract fish with an acoustical lure a lure 001 is painted, colored, and/or textured to resemble a particular type of fish.

In some embodiments of versions of an apparatus and system to attract fish with an acoustical lure a lure 001 may be of a size and look like, but not limited to, Atlantic Croakers; Pigfish; Spots.

In some embodiments of versions of an apparatus and system to attract fish with an acoustical lure a hook 002 is of a length, not meant to be limiting, of 1 inches to 5 inches.

In some embodiments of versions of an apparatus and system to attract fish with an acoustical lure a hook channel 007 may comprise a material like, not meant to be limiting, plastic, metal, carbon fiber.

In some embodiments of versions of an apparatus and system to attract fish with an acoustical lure a hook channel 007 may comprise a method for a hook 002 to pull free from the lure 001 and a lure may slide up a fishing line.

In some embodiments of versions of an apparatus and system to attract fish with an acoustical lure a hook 002 may be located longitudinally on the bottom of the lure 001.

In some embodiments of versions of an apparatus and system to attract fish with an acoustical lure a hook 002 may be, not meant to be limiting, pushed through the lure 001, molded into the lure 001, dangle below the lure 001, be on top of the lure 001, have an eyelet connected to the hook 002, be fed into the hook channel 007.

In some embodiments of versions of an apparatus and system to attract fish with an acoustical lure a hook 002 may be located longitudinally on the top of the lure 001.

In some embodiments of versions of an apparatus and system to attract fish with an acoustical lure a loudspeaker 004 is of a length, not meant to be limiting, of ½ inch to 3 inches; a height not meant to be limiting, of ½ inch to 3 inches; a thickness, not meant to be limiting, of ¼ inch to 1½ inches.

In some embodiments of versions of an apparatus and system to attract fish with an acoustical lure a loudspeaker 004 comprises a waterproof container; a self-contained power source; a transducer; a digital storage source; an activation switch to turn said loudspeaker on or off; and a sound emitting loudspeaker.

In some embodiments of versions of an apparatus and system to attract fish with an acoustical lure a loudspeaker 004 may have recorded sounds like, but not limited to, Atlantic Croakers; Pigfish; Spots.

In some embodiments of versions of an apparatus and system to attract fish with an acoustical lure a loudspeaker 004 may be of a type manufactured by bigDAWGS promotions, of New York, USA.

In some embodiments of versions of an apparatus and system to attract fish with an acoustical lure a slot 005 is of a length, not meant to be limiting, of 2 inches to 20 inches; a height not meant to be limiting, of 2 inches to 8 inches; a thickness, not meant to be limiting, of ½ inch to 6 inches.

In some embodiments of versions of an apparatus and system to attract fish with an acoustical lure a slot 005 may be located longitudinally on the bottom of the lure 001, either fore or aft of the hook 002.

In some embodiments of versions of an apparatus and system to attract fish with an acoustical lure a slot 005 may be located longitudinally on the top of the lure 001.

In some embodiments of versions of an apparatus and system to attract fish with an acoustical lure a slot 005 may be located on the side of the lure 001, and operate as a flap.

In some embodiments of versions of an apparatus and system to attract fish with an acoustical lure a slot cavity 008 may comprise a material like, not meant to be limiting, plastic, metal, carbon fiber.

In some embodiments of versions of an apparatus and system to attract fish with an acoustical lure a slot 005 maybe self closing.

In some embodiments of versions of an apparatus and system to attract fish with an acoustical lure a slot 005 may comprise a device to secure a slot 005 like, but not limited to, a clasp, holes and pegs, hook and loop fastener, a coupling mechanism, a clip, a snap lock mechanism.

In some embodiments of versions of an apparatus and system to attract fish with an acoustical lure a weight 006 may be, not meant to be limiting, made of lead or steel.

In some embodiments of versions of an apparatus and system to attract fish with an acoustical lure a spar 010 may be inserted in the lure to provide rigidity or structure to the lure.

In some embodiments of versions of an apparatus and system to attract fish with an acoustical lure a spar 010 may be one or a plurality of spars.

In some embodiments of versions of an apparatus and system to attract fish with an acoustical lure a spar 010 may run longitudinally within the lure 001. Spars 010 may also be laterally placed within the lure 001. A plurality of spars 010 may be of different lengths within the same lure 001.

In some embodiments of versions of an apparatus and system to attract fish with an acoustical lure a spar 010 may comprise a material made of, but not limited to, metal, aluminum, plastic.

In some embodiments of versions of an apparatus and system to attract fish with an acoustical lure in its most complete version comprise the following components: (1) a lure 001; (2) a loudspeaker 004; (3) a slot 005; (4) a hook 002; (5) a weight 006, (6) an eyelet 003 to connect to a fishing line; (7) a coupling device 009 to close the slot 005; (8) a pattern of coloring and reflective features on the lure to attract fish; (9) recordings of particular fish to play on the loudspeaker.

In some embodiments of versions of an apparatus and system to attract fish with an acoustical lure these components are connected as follows to result in a single system: (1) a hook 002 is inserted into a lure 001 longitudinally on the bottom of the lure 001; (2) a slot 005 runs longitudinally along the bottom of the lure 001, aft of the hook 002; (3) a loudspeaker 004 is inserted through the slot to stay in the lure 001; (5) a weight 006 inside the lure 001 in an ideal position to balance the speaker 006 and hook 002 about the lure's 001 center of gravity; (6) an eyelet 003 is connected to the hook 002; (7) a coupling device is used to close the slot 005; (8) a pattern of coloring and reflective features on the lure to attract fish is applied to the lure 001; (9) recordings of particular fish are recorded on the digital storage device in the loudspeaker 004.

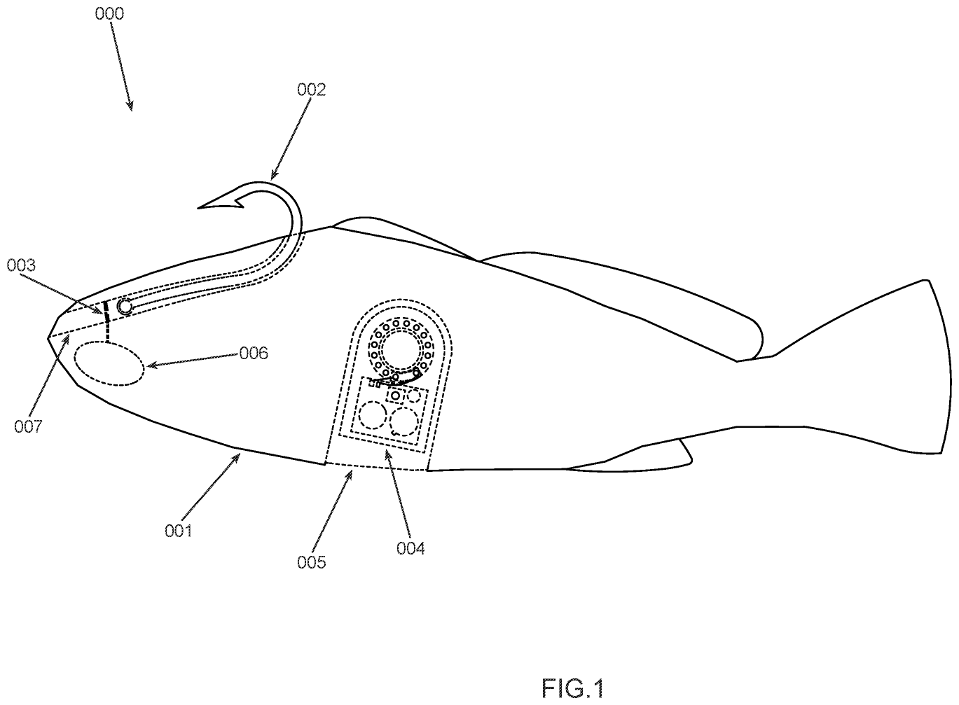

FIG. 1.—Shows a side view of the preferred embodiment of an apparatus and system to attract fish with an acoustical lure in its assembled version. A loudspeaker 004 is inserted through the slot 005 in the lure 001. A weight 006 with an eyelet 003 attached is positioned inside the lure 001 so the lure 001 is properly balanced. A hook 002 is inserted in the hook channel 007.

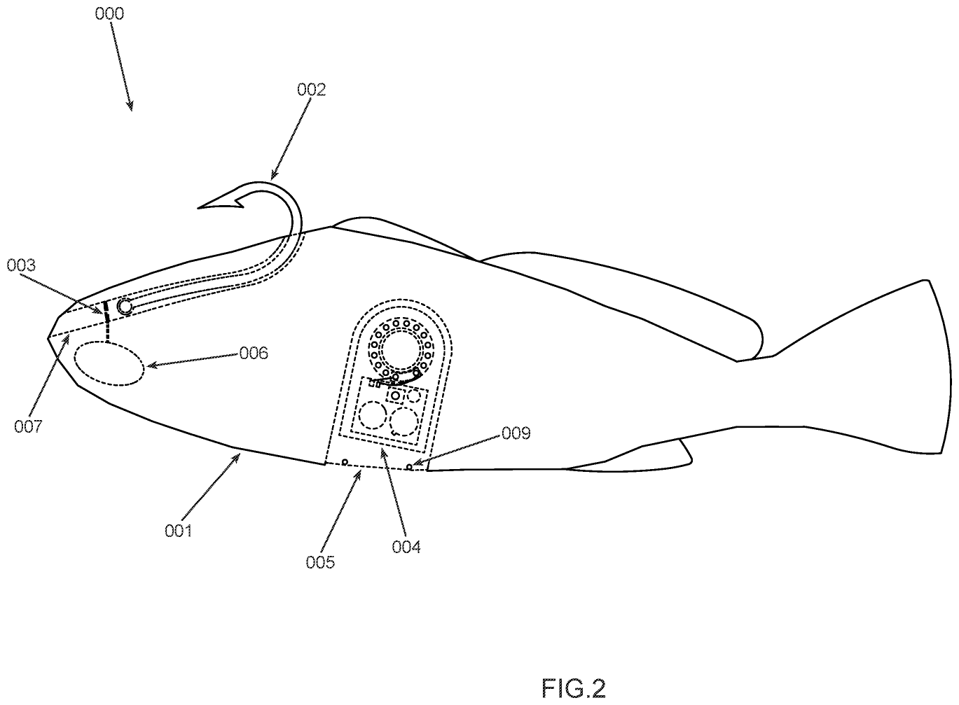

FIG. 2.—Shows a side view of the preferred embodiment of an apparatus and system to attract fish with an acoustical lure in its assembled version. A loudspeaker 004 is inserted through the slot 005 in the lure 001. A weight 006 with an eyelet 003 attached is positioned inside the lure 001 so the lure 001 is properly balanced. A hook 002 is inserted in the hook channel 007. A slot 005 has a coupling device 009, in this embodiment a hole and peg system is shown.

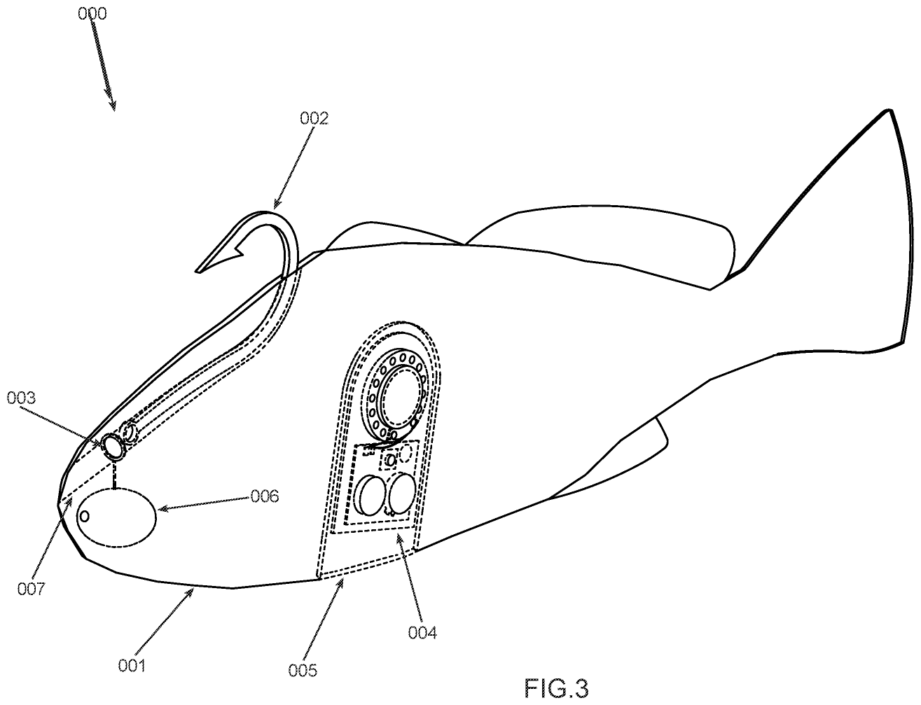

FIG. 3.—Shows a perspective view of the preferred embodiment of an apparatus and system to attract fish with an acoustical lure in its assembled version. A loudspeaker 004 is inserted through the slot 005 in the lure 001. A weight 006 with an eyelet 003 attached is positioned inside the lure 001 so the lure 001 is properly balanced. A hook 002 is inserted in the hook channel 007.

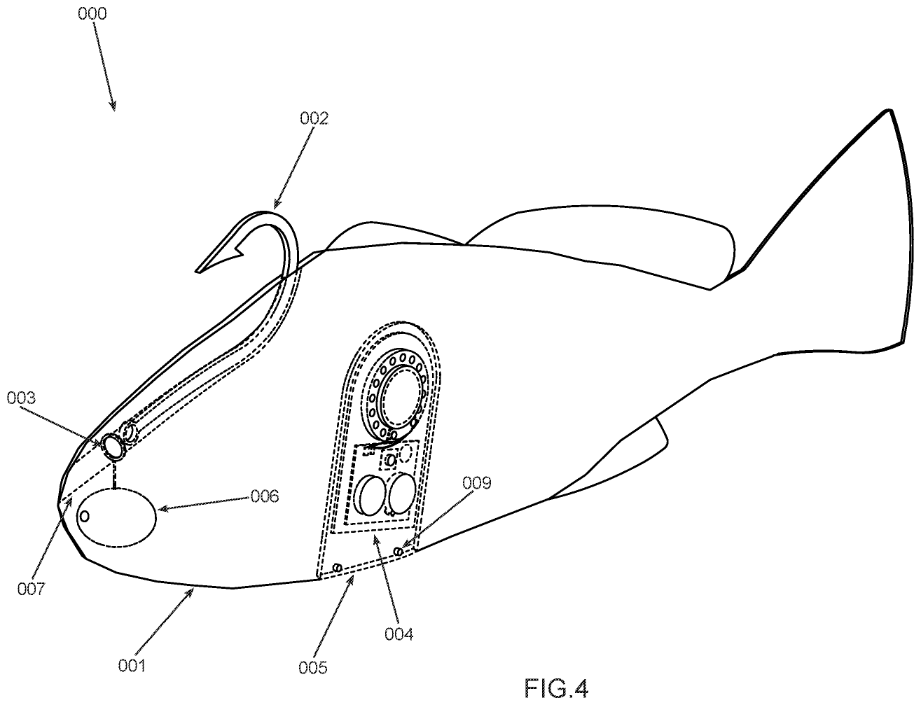

FIG. 4.—Shows a perspective view of the preferred embodiment of an apparatus and system to attract fish with an acoustical lure in its assembled version. A loudspeaker 004 is inserted through the slot 005 in the lure 001. A weight 006 with an eyelet 003 attached is positioned inside the lure 001 so the lure 001 is properly balanced. A hook 002 is inserted in the hook channel 007. A slot 005 has a coupling device 009, in this embodiment a hole and peg system is shown.

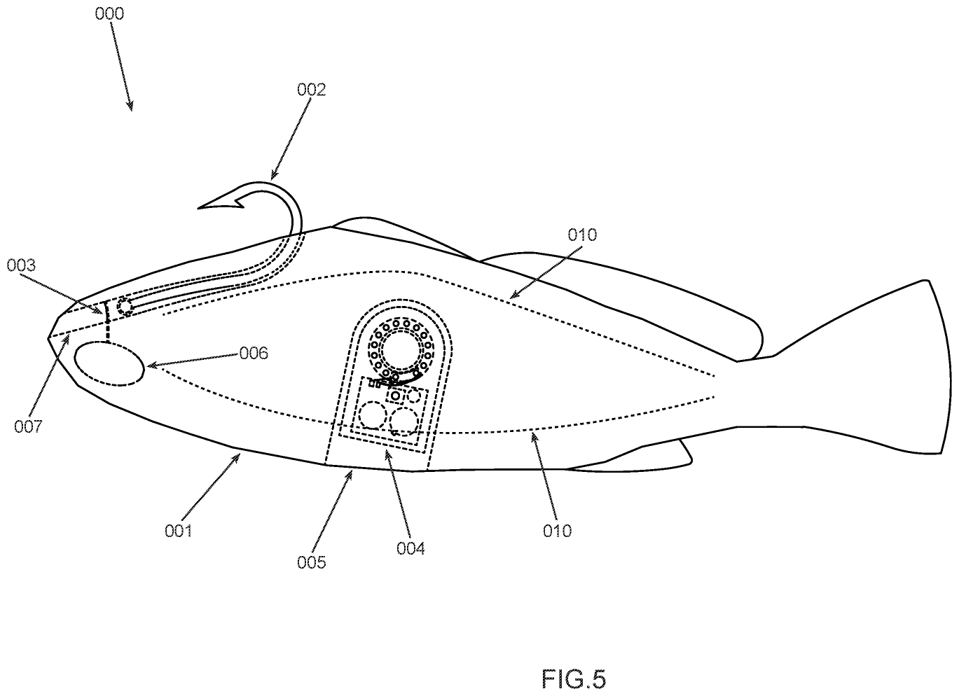

FIG. 5.—Shows a side view of the preferred embodiment of an apparatus and system to attract fish with an acoustical lure in its assembled version. A loudspeaker 004 is inserted through the slot 005 in the lure 001. A weight 006 with an eyelet 003 attached is positioned inside the lure 001 so the lure 001 is properly balanced. A hook 002 is inserted in the hook channel 007. In this embodiment, two spars 010, not meant to be limiting by number or direction, are shown at parallel and longitudinally to the top and bottom of the lure 001.

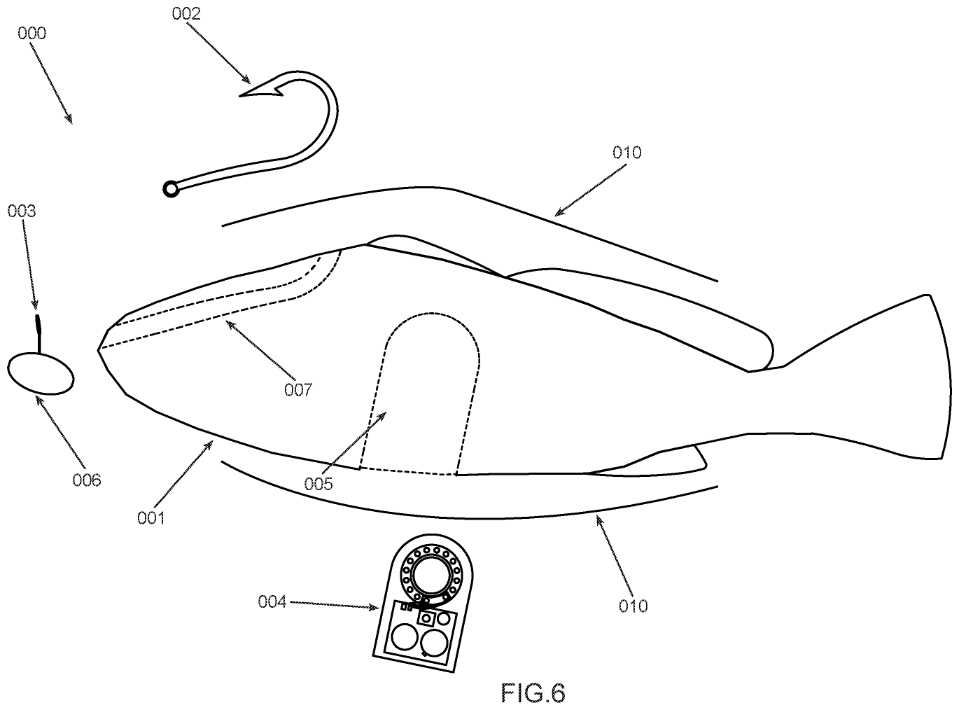

FIG. 6.—Shows a side view of the preferred embodiment of an apparatus and system to attract fish with an acoustical lure in its exploded unassembled version. Components shown include a molded fishing lure 001; a hook 002; an eyelet attached to a weight 006; a loudspeaker 004; a slot 005; a hook channel 007; a spar 010.

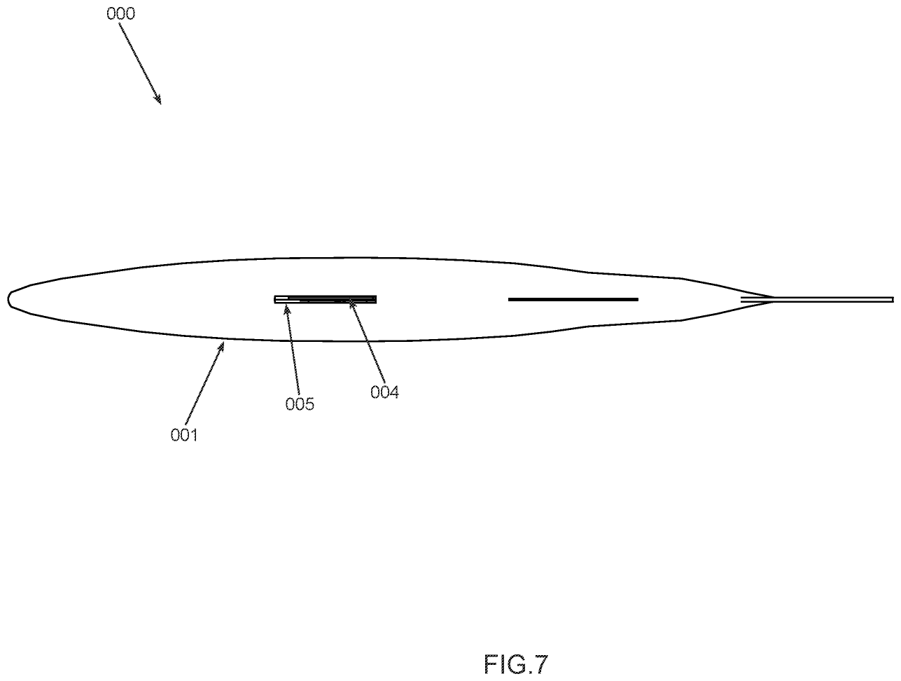

FIG. 7.—Shows a bottom view of the preferred embodiment of an apparatus and system to attract fish with an acoustical lure in its assembled version. A loudspeaker 004 is inserted through the slot 005 in the lure 001.

Versions of the invention may be a method of adapting a fishing rod with an apparatus and system to attract fish with an acoustical lure, comprising: selecting a hypothetical fishing rod and fishing line appropriate for an apparatus and system to attract fish with an acoustical lure comprising a lure 001, a slot 005; a loudspeaker 004; a hook 002; a weight 006.

Versions of an apparatus and system to attract fish with an acoustical lure may be made individually, in batches, or via continuous assembly.

For example, to make a version of an apparatus and system to attract fish with an acoustical lure prepare an appropriate work surface and assemble all of the components disclosed herein. Assemble the components in a logical order as someone skilled in the art would do. As an example, not meant to be limiting, start with a mold of a given length, height, and depth to create a lure 001. Within the mold, optionally, may be a hook channel 007 and a slot cavity 008. Layout a hook 002, a loudspeaker 004; a weight 006; an eyelet 003 if needed; obtain silicon of an appropriate type. Prepare the mold, using a releasing agent, and pour in the silicon. Allow to harden. When the silicon has hardened, remove the lure 001 from the mold. Choose the loudspeaker and insert the loudspeaker 004 into the slot 005. Insert the weight 006 into the lure 001. Insert the hook into the hook channel 007.

An example of using the apparatus comprises selecting an appropriate lure for the type of fish desired, selecting a loudspeaker with a recording of the appropriate bait fish, inserting the loudspeaker into the slot, attaching the lure to a fishing rod and line, activating the loudspeaker, casting the line to an appropriate area to fish.

Another example to use the assembled version of an apparatus and system to attract fish with an acoustical lure comprises selecting an appropriate lure for the type of fish desired, selecting a loudspeaker with a recording of the appropriate bait fish, inserting the loudspeaker into the slot, attaching the lure to a fishing rod and line, activating the loudspeaker, casting the line to an appropriate area to fish.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of an apparatus and system to attract fish with an acoustical lure may be utilized individually, concurrently, or in any sequential combination.

Those skilled in the art to which this application relates will appreciate that other and further additions, deletions, substitutions and modifications may be made to the described embodiments.

The specification is not to be taken in a limiting sense, but is made merely for the purpose of describing the general principles of exemplary embodiments; many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specifications, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing FIG. faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

What is claimed:

1. An apparatus and system to attract fish with an acoustical lure, comprising:
a lure of a given length, height, and thickness;
a slot of a given length, width, and depth;
a hook of a given length, width, and depth attached to the lure; and
a loudspeaker of a given length, width, and depth inside the lure further comprising
a waterproof container;
a self-contained power source;
a digital storage source;
an activation switch to turn said loudspeaker on or off;
and a sound emitting loudspeaker.

2. The apparatus and system to attract fish with an acoustical lure of claim 1 wherein said lure further comprising:
a flexible molded material.

3. The apparatus and system to attract fish with an acoustical lure of claim 1 wherein said lure further comprising:
a non-flexible molded material.

4. The apparatus and system to attract fish with an acoustical lure of claim 1 wherein said lure further comprising:
a weight in the lure.

5. The apparatus and system to attract fish with an acoustical lure of claim 1 wherein said lure further comprising:
a slot cavity.

6. The apparatus and system to attract fish with an acoustical lure of claim 1 wherein said lure further comprising:
a hook channel.

7. The apparatus and system to attract fish with an acoustical lure of claim 1 wherein said lure further comprising:
a spar or a plurality of spars.

8. The apparatus and system to attract fish with an acoustical lure of claim 1 wherein said lure further comprising a color, shape, and size selected from the group consisting of Atlantic Croakers, Pigfish, and Spots

9. The digital storage source of claim 1 further comprising a recording of the sound selected from the group consisting of Atlantic Croakers, Pigfish, and Spots.

10. The apparatus and system to attract fish with an acoustical lure of claim 1 wherein said slot further comprising:
a coupling device to secure the slot.

11. The apparatus and system to attract fish with an acoustical lure of claim 1 further comprising a fishing rod and fishing line.

12. A device to attract fish, comprising:
a lure of a given length, width, and depth;
a loudspeaker of a given length, width, and depth inside the lure;
a slot of a given length, width, and depth;
and a hook of a given length, width, and depth attached to the lure.

13. A method of fishing with an apparatus and system to attract fish with an acoustical lure, comprising:
selecting a fishing rod and fishing line appropriate for an apparatus and system to attract fish with an acoustical lure;
using an apparatus and system to attract fish with an acoustical lure comprising a lure; a loudspeaker; a slot; a hook;
wherein connecting said apparatus and system to attract fish with an acoustical lure to said fishing rod and line results in attracting fish.
